(19) United States
(12) Patent Application Publication
(10) Pub. No.: US 2025/0382914 A1
(43) Pub. Date: Dec. 18, 2025

(54) TURBOMACHINE COOLING AND ALTERNATIVE FUEL SUPPLY

(71) Applicant: GE Vernova Infrastructure Technology LLC, Greenville, SC (US)

(72) Inventor: Rajesh KUMAR, Karnataka (IN)

(21) Appl. No.: 19/237,616

(22) Filed: Jun. 13, 2025

(30) Foreign Application Priority Data
Jun. 18, 2024 (IN) 202411046887

(51) Int. Cl. F02C 7/18; C01B 3/04; C01B 21/02; F02C 3/22; F23R 3/30; F23R 3/36

(52) U.S. Cl. CPC F02C 7/18; C01B 3/047; C01B 21/02; F02C 3/22; F23R 3/30; F23R 3/36; F05D 2260/232

(57) ABSTRACT

A method of operating a turbomachine includes directing a flow of ammonia vapor to one or more hot gas path components of the turbomachine. As a result, heat is transferred to the ammonia vapor from the one or more hot gas path components. The method also includes cracking the ammonia vapor by the heat from the one or more hot gas path components, which causes a hydrogen gas and a nitrogen gas to be produced. The method further includes flowing the hydrogen gas produced by cracking the ammonia vapor to a combustor of the turbomachine. The invention also includes a turbomachine.

### CROSS-REFERENCE TO RELATED APPLICATION

This application claims priority pursuant to 35 U.S.C. 119(a) to Indian patent application Ser. No. 20/241,1046887, filed Jun. 18, 2024, which application is incorporated herein by reference in its entirety.

### FIELD

The subject matter disclosed herein relates generally to turbomachines and more specifically to methods and systems for operating turbomachines.

### BACKGROUND

Turbomachines are utilized in a variety of industries and applications for energy transfer purposes. Turbomachines, such as gas turbine engines, aero-derivatives, or the like, generally include, in serial flow order, a compressor, a combustion section, and a turbine (i.e., an expansion turbine). The compressor section progressively increases the pressure of a working fluid entering the gas turbine engine and supplies this compressed working fluid to the combustion section. The compressed working fluid and a fuel (e.g., natural gas) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases then exit the gas turbine via the exhaust section.

Burning the natural gas in the combustion section may create byproducts such as carbon monoxide (CO), nitrogen oxides (NOx), and other pollutants, which may then be expelled by the exhaust section, often after costly treatment to remove or reduce the level of undesirable constituents. Regulatory requirements for low emissions from gas turbines are continually growing more stringent, and environmental agencies throughout the world are now requiring even lower rates of emissions of CO, NOx, and other pollutants from both new and existing gas turbines. Alternative fuels, such as ammonia (NH₃) and/or hydrogen (H₂), can be used as a substitute for natural gas to reduce the production of emissions in the combustor. Providing or producing such alternative fuels, however, typically leads to increased complexity and operating expense for the turbomachine. For example, some systems include a dedicated heater or heat exchanger for cracking ammonia (e.g., by thermal decomposition) to generate hydrogen for use as an alternative fuel.

The turbomachine generally includes a plurality of components that receive or are otherwise exposed to the high temperature combustion gases. Such components, which lie along a flow path of the hot combustion gases, may be referred to as “hot gas path” components. Various cooling features may be provided to limit the temperatures of the hot gas path components during operation of the turbomachine, such as a coolant gas may be flowed to and/or through at least some of the hot gas path components. For example, the hot gas path components may include stator vanes (also referred to as “nozzles”) and rotor blades in the turbine section of the turbomachine.

Accordingly, improved systems and methods for cooling a turbomachine while providing alternative fuel for the turbomachine would be useful and are desired in the art.

### SUMMARY

Aspects and advantages of systems and methods in accordance with the present disclosure will be set forth in part in the following description, or may be obvious from the description, or may be learned through practice of the technology.

In accordance with one embodiment, a method of operating a turbomachine is provided. The method includes directing a flow of ammonia vapor to one or more hot gas path components of the turbomachine. As a result, heat is transferred to the ammonia vapor from the one or more hot gas path components. The method also includes cracking the ammonia vapor by the heat from the one or more hot gas path components, which produces a hydrogen gas and a nitrogen gas. The method further includes flowing the hydrogen gas produced by cracking the ammonia vapor to a combustor of the turbomachine.

In accordance with another embodiment, a turbomachine is provided. The turbomachine includes one or more hot gas path components, a combustor, and a controller. The controller is configured for directing a flow of ammonia vapor to the one or more hot gas path components of the turbomachine. As a result, heat is transferred to the ammonia vapor from the one or more hot gas path components. The ammonia vapor may be cracked by the heat from the one or more hot gas path components, which produces a hydrogen gas and a nitrogen gas. The controller is further configured for flowing the hydrogen gas produced by cracking the ammonia vapor to the combustor of the turbomachine.

These and other features, aspects, and advantages of the present systems and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present systems and methods, including the best mode of making and using the present systems and methods, directed to one of ordinary skill in the art, is set forth in the specification, which makes reference to the appended figures.

FIG. 1 provides a functional block diagram of an exemplary turbomachine that may incorporate various embodiments of the present technology;

FIG. 2 provides a schematic block diagram of components of the turbomachine as shown in FIG. 1 including an exemplary embodiment of a cooling and alternative fuel system according to one or more embodiments of the present disclosure;

FIG. 3 provides a schematic illustration of an exemplary hot gas path component of a turbomachine such as the exemplary turbomachine of FIG. 1; and,

FIG. 4 provides a flowchart diagram of an exemplary method of operating a turbomachine according to one or more embodiments of the present disclosure;

### DETAILED DESCRIPTION

Reference now will be made in detail to embodiments of the present systems and methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the technology. As used herein, the terms “first,” “second,” and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. However, the terms “upstream” and “downstream” as used herein may also refer to a flow of electricity. The term “radially” refers to the relative direction that is substantially perpendicular to an axial centerline of a particular component, the term “axially” refers to the relative direction that is substantially parallel and/or coaxially aligned to an axial centerline of a particular component, and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “and/or” is inclusive of any combinations of one or more items listed. For example, a condition A and/or B is satisfied by any one of the following: A is true (or present) and B is false (or not present), A is false (or not present) and B is true (or present), and both A and B are true (or present).

Here and throughout the specification and claims, where range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Each example is provided by way of explanation of the technology, not limitation of the technology. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present technology covers such modifications and variations as come within the scope of the appended claims and their equivalents. Although exemplary embodiments will be described generally in the context of a turbomachine cooling and alternative fuel supply system for a land-based, power-generating gas turbine for purposes of illustration, one of ordinary skill in the art will readily appreciate that embodiments of the present technology may be applied to any inlet system for any type of turbomachine and are not limited to land-based, power-generating gas turbines unless specifically recited in the claims.

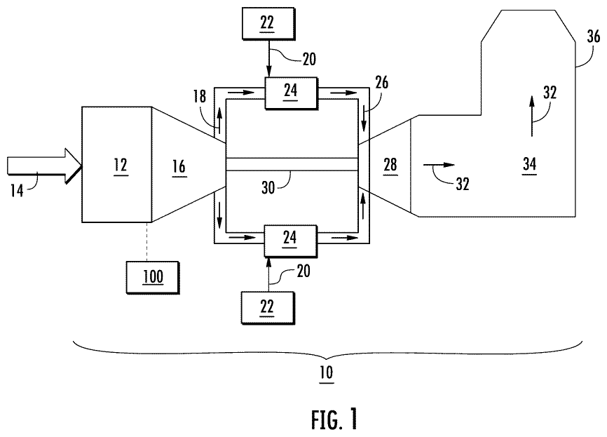

Referring now to the drawings, in which identical numerals indicate the same elements throughout the figures, FIG. 1 provides a functional block diagram of an exemplary turbomachine, which in the illustrated exemplary embodiment is a gas turbine 10, that may incorporate various embodiments of the present technology. As shown, the gas turbine 10 generally includes an inlet system 12 that may include a series of filters, cooling coils, moisture separators, and/or other devices to purify and otherwise condition a flow of air 14 or other working fluid entering the gas turbine 10. The air 14 flows from the inlet system 12 to a compressor section where a compressor 16 progressively imparts kinetic energy to the air 14 to produce compressed air 18.

The compressed air 18 is mixed with a fuel 20 from a fuel supply system 22 to form a combustible mixture within one or more combustors 24. The combustible mixture is burned to produce combustion gases 26 having a high temperature, pressure, and velocity. The combustion gases 26 flow through a turbine 28 (i.e., an expansion turbine) of a turbine section to produce work. For example, the turbine 28 may be connected to a shaft 30 so that rotation of the turbine 28 drives the compressor 16 to produce the compressed air 18. Alternately, or in addition, the shaft 30 may connect the turbine 28 to a generator (not shown) for producing electricity. Exhaust gases 32 from the turbine 28 flow through an exhaust section 34 that connects the turbine 28 to an exhaust stack 36 downstream from the turbine 28. The exhaust section 34 may include, for example, a heat recovery steam generator (not shown) for cleaning and extracting additional heat from the exhaust gases 32 prior to release to the environment.

In at least some embodiments, the turbomachine, e.g., gas turbine 10, may further include or be in operative communication with a processing device or a controller 100 that may be generally configured to facilitate operation of the turbomachine. In this regard, controller 100 may be in communication with various pumps, valves, user input devices, sensors, and other control elements of the gas turbine 10, such that controller 100 may receive control inputs from the user input devices and sensors and may otherwise regulate operation of gas turbine 10. For example, signals generated by controller 100 may operate gas turbine 10, including any or all system components, subsystems, or interconnected devices, in response to the position of user input devices and other control commands. The user input devices, sensors, and other components (e.g., pumps, valves, etc.) of gas turbine 10 may be in communication with controller 100 via, for example, one or more signal lines or shared communication busses. In this manner, Input/Output (“I/O”) signals may be routed between controller 100 and various operational components of gas turbine 10. The communication may be hard-wired or wireless.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate turbomachine operation. Alternatively, controller 100 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 100 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 100 may be operable to execute programming instructions or micro-control code associated with an operating cycle of gas turbine 10. In this regard, the instructions may be software or any set of instructions that, when executed by the processing device, cause the processing device to perform operations, such as running one or more software applications, displaying a user interface, receiving user input, processing user input, etc. Moreover, it should be noted that controller 100 as disclosed herein is capable of and may be operable to perform any methods, method steps, or portions of methods as disclosed herein. For example, in some embodiments, methods disclosed herein may be embodied in programming instructions stored in the memory and executed by controller 100.

The memory devices may also store data that can be retrieved, manipulated, created, or stored by the one or more processors or portions of controller 100. The data can include, for instance, data to facilitate performance of methods described herein. The data can be stored locally (e.g., on controller 100) in one or more databases and/or may be split up so that the data is stored in multiple locations. In addition, or alternatively, the one or more database(s) can be connected to controller 100 through any suitable network(s), such as through a high bandwidth local area network (LAN) or wide area network (WAN). In this regard, for example, controller 100 may further include a communication module or interface that may be used to communicate with one or more other component(s) of gas turbine 10, controller 100, an external controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

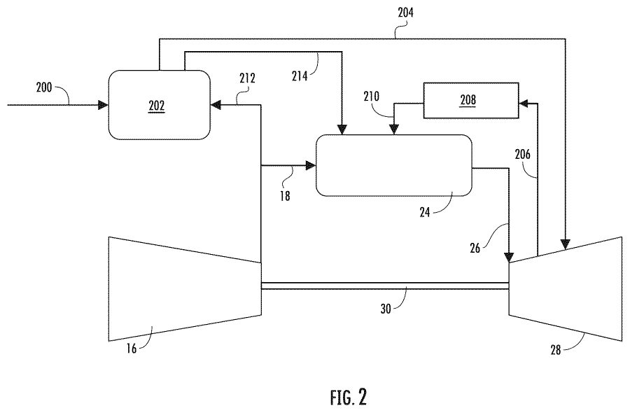

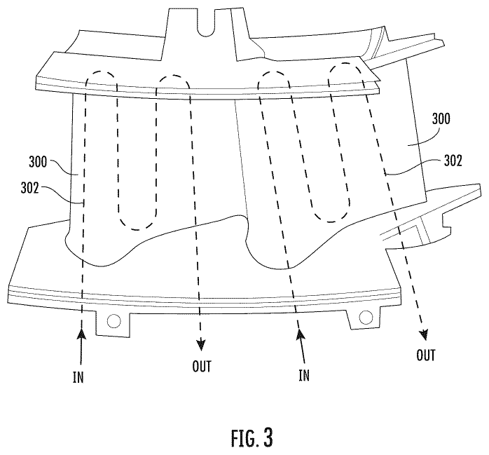

FIG. 2 is a schematic illustration of a vapor circulation system which may be incorporated into a turbomachine such as the exemplary gas turbine 10 described above. As illustrated in FIG. 2, the exemplary vapor circulation system may include a Cooled Cooling Air (CCA) system 202 or fuel preheat system (not shown), which includes a heat exchanger and which may receive a flow of liquid ammonia (NH₃) 200. The liquid ammonia 200 may be vaporized in the cooling air system 202 that uses the heat from compressed air (18 in FIG. 1), or the liquid ammonia 200 may be vaporized in fuel preheat system that uses heat from exhaust gases (32 in FIG. 1) or steam. Thus, a flow of vaporized ammonia 204 is generated, which may be flowed to one or more hot gas path components, such as may be located in the turbine section of the gas turbine, such as a nozzle 300 (see, e.g., FIG. 3) of the turbine 28. In some embodiments, the vaporized ammonia 204 may be entrained in or otherwise combined with a flow of cooling air, or the vaporized ammonia may be the only cooling gas provided to the one or more hot gas path components. The cooling air system 202 may also receive a portion of the high-pressure and high-temperature air from the compressor 16, e.g., a flow of compressed air 212 as illustrated in FIG. 2. A cooled cooling air flow 214 may be used to cool parts of the combustor or turbine.

As will be described further below with reference to FIG. 3, the vapor circulation system may extend through the one or more hot gas path components. Thus, heat may be transferred from the hot gas path component(s) to the gases (e.g., vaporized ammonia) in the vapor circulation system. As illustrated in FIG. 2, a stream of heated vapors 206, e.g., including hot vaporized ammonia, may thereby be generated.

After flowing to, through, and/or around the one or more hot gas path components, the ammonia may be at least partially cracked, i.e., thermally broken down to hydrogen (H₂) and nitrogen (N₂) molecules due to the heat from the one or more hot gas path components. That is, as the vaporized ammonia travels through the hot gas path and/or the turbine section more generally, the ammonia may be thermally decomposed by the heat from the one or more hot gas path components, thereby resulting in a mixture of nitrogen, hydrogen, and remaining ammonia that has not been cracked (if any).

The heated vapors 206 may be flowed from the turbine section to a catalyst 208, where heat transferred from the hot gas path components to the vapors 206 improves the efficiency of the catalyst 208. The catalyst 208 may include a metallic material such as nickel, iron, ruthenium, cobalt, other similar materials, and combinations of any one or more of such materials. The material of the catalyst 208 may be selected based on the expected operating temperatures, e.g., relatively available and inexpensive materials such as nickel-based or iron-based catalyst materials may be used provided the temperature of the heated vapors 206 is high enough, e.g., at least about 600° C. to 700° C. at the low end of the operating temperature range. The catalyst 208 reacts with ammonia in the heated vapors 206 to further break down, e.g., crack, the remaining ammonia into hydrogen and nitrogen.

Thus, a flow of hydrogen (H₂)-containing fluid 210 may be produced by cracking the ammonia and, as indicated in FIG. 2, the hydrogen-containing fluid 210 may be flowed to one or more combustors 24 of the turbomachine, e.g., gas turbine 10, where it may be used as a fuel. The hydrogen-containing fluid 210 (also referred to herein as “hydrogen fuel 210”) may then be burned in the combustor 24 to produce combustion gases 26, e.g., as described above. Thus, the hydrogen fuel 210 may provide an alternative fuel for the combustor 24, e.g., to at least partially replace natural gas fuel.

A pair of exemplary hot gas path components are illustrated in FIG. 3. In some embodiments, the hot gas path component to which the ammonia vapor is directed may be a nozzle 300 of the turbine 28. Those of ordinary skill in the art will recognize that the nozzle 300 of the turbine 28 may be part of an annular array of stationary airfoil structures which extend around a central axis of the turbine 28 (e.g., the shaft 30 may extend along or generally parallel to the central axis). The illustrated component in FIG. 3 comprises a section of such annular array which includes two nozzles 300. The turbine 28 may include multiple stages, with each stage including an annular array of nozzles (which are stationary and thus may also be referred to as stators or stator vanes) that channel and direct the combustion gases 26 to and towards an annular array of rotor blades adjacent to the nozzles of the stage. A subsequent stage, e.g., another set of nozzles, may be adjacent to and immediately downstream of the rotor blades of the preceding stage. For example, the illustrated nozzles 300 shown in FIG. 3 may be first stage nozzles, e.g., may be part of an annular array of nozzles at the inlet of the turbine section, such as the first set of nozzles which receive the combustion gases 26 from the combustors 24.

An exemplary cooling gas flow path through each nozzle 300 is illustrated by dashed lines in FIG. 3. The cooling gas may flow through the nozzles 300, e.g., as described above. For example, the cooling gas flow path may include a cooling circuit 302 within and through each nozzle 300. Thus, heat may be transferred from nozzles 300, which are exemplary hot gas path components, to the gas flowing therethrough, such as through the cooling circuit 302 in each nozzle 300. Such heat transfer, e.g., cooling of the nozzles 300, may beneficially reduce thermal and/or mechanical loads on the nozzles 300 during operation of the turbomachine. Additionally, the heating of the gas may advantageously support the cracking of the vaporized ammonia in the cooling gas stream, i.e., the ammonia may be at least partially cracked by the heat from the one or more hot gas path components.

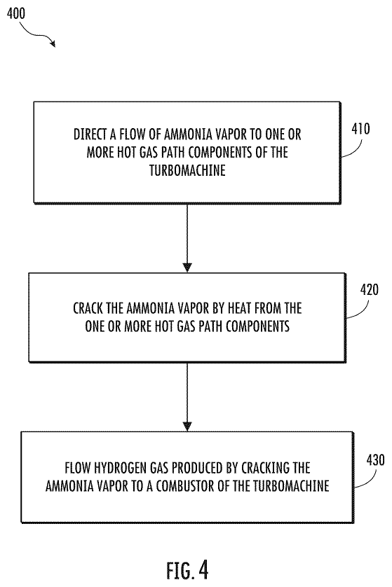

Referring now to FIG. 4, embodiments of the present disclosure also include methods of operating a turbomachine, such as the exemplary method 400 illustrated in FIG. 4. Such methods may be used to operate any suitable turbomachine, such as but not limited to the exemplary gas turbine 10 described above.

Referring now to FIG. 4 in particular, exemplary method 400 may include (410) directing a flow of ammonia vapor to one or more hot gas path components of the turbomachine. As a result of such flow, heat is transferred to the ammonia vapor from the one or more hot gas path components. As noted above, such heat transfer may advantageously increase the temperature of the ammonia vapor, e.g., to crack the ammonia or promote cracking thereof, and may also advantageously lower the temperature of the one or more hot gas path components.

Thus, methods such as method 400 may also include (420) cracking the ammonia vapor by the heat from the one or more hot gas path components, such as at least partially thermally disassociating the ammonia vapor into hydrogen gas and nitrogen gas. Thus, cracking the ammonia vapor may result in a gaseous mixture of hydrogen gas and nitrogen gas being produced. The hydrogen-containing gas mixture may then be flowed to a combustor for use as a fuel, where the hydrogen-containing gas mixture is burned to produce combustion gases that are provided to a turbine. For example, as indicated at (430) in FIG. 4, method 400 may include flowing the hydrogen gas produced by cracking the ammonia vapor to a combustor of the turbomachine.

In some embodiments, method 400 may also include flowing the ammonia vapor across a catalyst. In such embodiments, the ammonia vapor may be cracked by interaction with the catalyst and by the heat from the one or more hot gas path components. For example, the catalyst may be downstream of the one or more hot gas path components, such that the ammonia vapor is heated by the one or more hot gas path components before flowing the ammonia vapor across the catalyst. Heating the ammonia vapor before flowing across the catalyst may advantageously increase the reaction rate of the ammonia vapor and the catalyst, thereby providing more complete cracking of the ammonia and/or permitting the use of more readily available and economical catalyst materials.

In some embodiments, method 400 may also include providing a flow of liquid ammonia to a cooling air system, such as a CCA system (e.g., as described above with reference to FIG. 2), of the turbomachine. Such embodiments may further include generating the flow of ammonia vapor from the liquid ammonia in the cooling air system of the turbomachine. In some embodiments, the cooling air system, a turbine section of the turbomachine, and the combustor of the turbomachine may form a closed ammonia vapor circuit. For example, the vapor circulation system of FIG. 2, as discussed above, may include a closed circuit through which the vaporized ammonia flows such that the ammonia vapor is contained within the circuit, e.g., through the complete cycle beginning with vaporizing the liquid ammonia in the cooling air system 202 until breaking the vaporized ammonia into a mixture of hydrogen gas and nitrogen gas. Accordingly, the vaporized ammonia may be contained in the vapor circulation system and not exposed to, or allowed to escape into, the ambient environment around the turbomachine.

In some embodiments, method 400 may further include flowing the nitrogen gas produced by cracking the ammonia vapor to the combustor of the turbomachine, e.g., the hydrogen-containing fluid 210 may further contain nitrogen resultant from the cracking of the ammonia, and the nitrogen gas may be flowed with the hydrogen gas. For example, the nitrogen gas may be a power augmentation source for the gas turbine, such as the pressure of the nitrogen gas may help to push combustion gases from the combustor into and through the turbine.

In some embodiments, (410) directing the flow of ammonia vapor to the one or more hot gas path components of the turbomachine may include flowing the ammonia vapor through a cooling circuit within at least one of the one or more hot gas path components of the turbomachine. For example, the cooling circuit may be a serpentine channel within one or more nozzles, e.g., as illustrated in FIG. 3 and described above. For example, in some embodiments, the one or more hot gas path components of the turbomachine may be or may include a nozzle in a turbine section of the turbomachine, such as a first stage nozzle.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A method of operating a turbomachine, the method comprising directing a flow of ammonia vapor to one or more hot gas path components of the turbomachine, whereby heat is transferred to the ammonia vapor from the one or more hot gas path components, cracking the ammonia vapor by the heat from the one or more hot gas path components, whereby a hydrogen gas and a nitrogen gas are produced, and flowing the hydrogen gas produced by cracking the ammonia vapor to a combustor of the turbomachine.

The method of one or more of these clauses, further comprising flowing the ammonia vapor across a catalyst, wherein the ammonia vapor is cracked by interaction with the catalyst and by the heat from the one or more hot gas path components.

The method of one or more of these clauses, wherein the catalyst is downstream of the one or more hot gas path components, whereby the ammonia vapor is heated by the one or more hot gas path components before flowing the ammonia vapor across the catalyst.

The method of one or more of these clauses, further comprising providing a flow of liquid ammonia to a cooling air system of the turbomachine and generating the flow of ammonia vapor from the liquid ammonia in the cooling air system of the turbomachine.

The method of one or more of these clauses, wherein the cooling air system, a turbine section of the turbomachine, and the combustor of the turbomachine form a closed ammonia vapor circuit.

The method of one or more of these clauses, further comprising flowing the nitrogen gas produced by cracking the ammonia vapor to the combustor of the turbomachine.

The method of one or more of these clauses, wherein directing the flow of ammonia vapor to the one or more hot gas path components of the turbomachine comprises flowing the ammonia vapor through a cooling circuit within at least one of the one or more hot gas path components of the turbomachine.

The method of one or more of these clauses, wherein the one or more hot gas path components of the turbomachine comprises a nozzle in a turbine section of the turbomachine.

The method of one or more of these clauses, wherein the nozzle is a first stage nozzle.

Further aspects of the invention are provided by the subject matter of the following clauses:

A turbomachine, comprising one or more hot gas path components, a combustor, and a controller, the controller configured for directing a flow of ammonia vapor to the one or more hot gas path components of the turbomachine, whereby heat is transferred to the ammonia vapor from the one or more hot gas path components, cracking the ammonia vapor by the heat from the one or more hot gas path components, whereby a hydrogen gas and a nitrogen gas are produced, and flowing the hydrogen gas produced by cracking the ammonia vapor to the combustor of the turbomachine.

The system of one or more of these clauses, further comprising a catalyst, wherein the controller is further configured for flowing the ammonia vapor across the catalyst, wherein the ammonia vapor is cracked by interaction with the catalyst and by the heat from the one or more hot gas path components.

The system of one or more of these clauses, wherein the catalyst is downstream of the one or more hot gas path components, whereby the ammonia vapor is heated by the one or more hot gas path components before flowing the ammonia vapor across the catalyst.

The system of one or more of these clauses, further comprising a cooling air system, wherein the controller is further configured for providing a flow of liquid ammonia to the cooling air system of the turbomachine and generating the flow of ammonia vapor from the liquid ammonia in the cooling air system of the turbomachine.

The system of one or more of these clauses, wherein the cooling air system, a turbine section of the turbomachine, and the combustor of the turbomachine form a closed ammonia vapor circuit.

The system of one or more of these clauses, wherein the controller is further configured for flowing the nitrogen gas produced by cracking the ammonia vapor to the combustor of the turbomachine.

The system of one or more of these clauses, further comprising a cooling circuit within at least one of the one or more hot gas path components, wherein directing the flow of ammonia vapor to the one or more hot gas path comprises flowing the ammonia vapor through the cooling circuit.

The system of one or more of these clauses, wherein the one or more hot gas path components of the turbomachine comprises a nozzle in a turbine section of the turbomachine.

The system of one or more of these clauses, wherein the nozzle is a first stage nozzle.

1. A method of operating a turbomachine, the method comprising:
directing a flow of ammonia vapor to one or more hot gas path components of the turbomachine, whereby heat is transferred to the ammonia vapor from the one or more hot gas path components;
cracking the ammonia vapor by the heat from the one or more hot gas path components, whereby a hydrogen gas and a nitrogen gas are produced; and
flowing the hydrogen gas produced by cracking the ammonia vapor to a combustor of the turbomachine.

2. The method of claim 1, further comprising flowing the ammonia vapor across a catalyst, wherein the ammonia vapor is cracked by interaction with the catalyst and by the heat from the one or more hot gas path components.

3. The method of claim 2, wherein the catalyst is downstream of the one or more hot gas path components, whereby the ammonia vapor is heated by the one or more hot gas path components before flowing the ammonia vapor across the catalyst.

4. The method of claim 1, further comprising providing a flow of liquid ammonia to a cooling air system of the turbomachine and generating the flow of ammonia vapor from the liquid ammonia in the cooling air system of the turbomachine.

5. The method of claim 4, wherein the cooling air system, a turbine section of the turbomachine, and the combustor of the turbomachine form a closed ammonia vapor circuit.

6. The method of claim 1, further comprising flowing the nitrogen gas produced by cracking the ammonia vapor to the combustor of the turbomachine.

7. The method of claim 1, wherein directing the flow of ammonia vapor to the one or more hot gas path components of the turbomachine comprises flowing the ammonia vapor through a cooling circuit within at least one of the one or more hot gas path components of the turbomachine.

8. The method of claim 1, wherein the one or more hot gas path components of the turbomachine comprises a nozzle in a turbine section of the turbomachine.

9. The method of claim 8, wherein the nozzle is a first stage nozzle.

10. A turbomachine, comprising:
one or more hot gas path components;
a combustor; and
a controller, the controller configured for:
directing a flow of ammonia vapor to the one or more hot gas path components of the turbomachine, whereby heat is transferred to the ammonia vapor from the one or more hot gas path components;
cracking the ammonia vapor by the heat from the one or more hot gas path components, whereby a hydrogen gas and a nitrogen gas are produced; and
flowing the hydrogen gas produced by cracking the ammonia vapor to the combustor of the turbomachine.

11. The turbomachine of claim 10, further comprising a catalyst, wherein the controller is further configured for flowing the ammonia vapor across the catalyst, wherein the ammonia vapor is cracked by interaction with the catalyst and by the heat from the one or more hot gas path components.

12. The turbomachine of claim 11, wherein the catalyst is downstream of the one or more hot gas path components, whereby the ammonia vapor is heated by the one or more hot gas path components before flowing the ammonia vapor across the catalyst.

13. The turbomachine of claim 10, further comprising a cooling air system, wherein the controller is further configured for providing a flow of liquid ammonia to the cooling air system of the turbomachine and generating the flow of ammonia vapor from the liquid ammonia in the cooling air system of the turbomachine.

14. The turbomachine of claim 13, wherein the cooling air system, a turbine section of the turbomachine, and the combustor of the turbomachine form a closed ammonia vapor circuit.

15. The turbomachine of claim 10, wherein the controller is further configured for flowing the nitrogen gas produced by cracking the ammonia vapor to the combustor of the turbomachine.

16. The turbomachine of claim 10, further comprising a cooling circuit within at least one of the one or more hot gas path components, wherein directing the flow of ammonia vapor to the one or more hot gas path comprises flowing the ammonia vapor through the cooling circuit.

17. The turbomachine of claim 10, wherein the one or more hot gas path components of the turbomachine comprises a nozzle in a turbine section of the turbomachine.

18. The turbomachine of claim 17, wherein the nozzle is a first stage nozzle.
